(19) United States
(12) Patent Application Publication
(10) Pub. No.: US 2020/0096424 A1
(43) Pub. Date: Mar. 26, 2020

(54) LIQUID FILM GENERATING TOOL

(71) Applicant: FEMTO Deployments Inc., Okayama-shi, Okayama (JP)

(72) Inventors: Akira WATANABE, Okayama-shi, Okayama (JP); Bunpei DOI, Okayama-shi, Okayama (JP); Tadashi OKUNO, Okayama-shi, Okayama (JP); Takeji UEDA, Okayama-shi, Okayama (JP)

(21) Appl. No.: 16/613,286

(22) PCT Filed: May 16, 2018
(86) PCT No.: PCT/JP2018/018900

§ 371 Date: Nov. 13, 2019

(30) Foreign Application Priority Data
May 18, 2017 (JP) 2017-098733

(51) Int. Cl. G01N 1/28; G01N 21/3577; G01N 21/3581

(52) U.S. Cl. CPC G01N 1/28; G01N 2021/3595; G01N 21/3581; G01N 21/3577

(57) ABSTRACT

A flat plate-like space region 13A formed between an inflow port 11A and an outflow port 11B of liquid has a predetermined thickness, and the planar shape of the space region 13A is configured in a shape in which the surface tensions generated, by liquid supplied to the space region 13A, from different places in a contour portion of the space region 13A toward the inner side of the space region 13A interact with each other. Thus, when the liquid is supplied to the space region 13A of a liquid film generating tool 100A from the outside, the liquid spreads in a plate shape along the shape of the space region 13A, and the surface tensions generated toward the inner side of the space region 13 can interact with each other to form a liquid film.

### TECHNICAL FIELD

The present invention relates to a liquid film generating tool, and more particularly to a tool for generating a liquid film as a liquid sample, in a system in which the liquid sample is placed in a path through which an electromagnetic wave propagates and characteristics of electromagnetic waves transmitted through the liquid sample is measured.

### BACKGROUND ART

In related art, there has been provided a spectroscopic apparatus that measures characteristics of a substance, using an electromagnetic wave such as a terahertz wave. For example, an absorption spectroscopy has been known in which the electromagnetic wave is allowed to transmit through a sample to be subjected to spectroscopic measurement, and characteristics of the sample are measured from changes in electromagnetic waves caused by an interaction between the electromagnetic waves and the sample while passing through the sample.

In the absorbance spectroscopy, for example, in order to perform a measurement with high accuracy on a liquid sample having a strong absorption effect, it is necessary to form a thin liquid sample to such an extent that the electromagnetic waves transmit. In particular, when spectroscopically measuring the liquid sample with the terahertz wave, since the absorption effect of the terahertz wave due to the water molecule is strong, in order to prevent deterioration of an SN ratio of a measurement signal, it is required to make the liquid into a plate-like uniform thin film, and to cause the terahertz wave to transmit through the plate-like portion to perform the measurement.

In general, in the measurement of the liquid sample, the sample is sandwiched in containers (generally called solution cells) made of a material such as a glass through which the electromagnetic waves transmit, the electromagnetic waves are incident from the outside of the solution cell, and the electromagnetic waves transmitted through the solution cell are measured. However, when the liquid sample is sandwiched between solution cells and measured, spectroscopic information of the cell material is superimposed as noise on the spectroscopic information of the liquid sample, which interferes with measurement of true spectroscopic information.

In related art, in view of such a problem, apparatuses aiming at making it possible to measure the spectroscopic information with little noise without using a solution cell have been proposed (see, for example, Patent Documents 1 and 2). In the apparatuses described in Patent Documents 1 and 2, by ejecting the liquid sample from a nozzle by the pressure of a pump, using the nozzle having a special structure, a thin flat plate-like liquid film is generated.

That is, as illustrated in FIG. 4 of Patent Document 2, two string-like fluid columns are formed by the liquid ejected from the tip of the nozzle. The two string-like fluid columns collide with each other at a fluid column assembly point, while drawing a smooth arc, and a liquid film is formed by surface tension of the liquid generated between the two fluid columns from the tip of the nozzle to the fluid column assembly point.

However, in the case of a liquid having a low surface tension such as a surfactant, there has been a problem of difficulty in forming a thin liquid film by ejecting the liquid sample. Further, there is a need for a certain amount or more of a liquid sample to continue to generate a thin liquid film due to the ejection of the liquid sample for a period of time required for measuring the terahertz wave. For this reason, there is a problem of difficulty in measuring spectroscopic information using the liquid, which is difficult to collect a certain amount or more, as a sample.
Patent Document 1: JP-A-2011-127950
Patent Document 2: JP-A-2015-219088

### SUMMARY OF THE INVENTION

The invention has been made to solve such a problem, and an object of the invention is to allow formation of a liquid film even from a liquid having a low surface tension. Further, another object of the invention is to allow generation of a liquid film continuously for a period of time required for measuring a terahertz wave, even from a liquid of less than a certain amount.

In order to solve the above-mentioned problem, the liquid film generating tool of the invention includes a flat plate-like space region having a predetermined thickness. Here, the planar shape of the space region is configured in such a shape that the surface tensions generated, by the liquid supplied to the space region, from the different places of the contour portion of the space region toward the inner side of the space region interact with each other.

According to the invention configured as described above, when a liquid is supplied to the space region of the liquid film generating tool from the outside, the liquid spreads in a plate shape along the shape of the space region. Surface tension is generated from the different places of the contour portions of the space region toward the inside of the space region, in the liquid that spreads in the plate shape in the space region. According to the invention, since the space region is formed in such a shape that the surface tensions generated from the different places of the contour portions of the space region interact with each other, even in the case of the liquid in which, if the liquid film generating tool is not used, the surface tension is insufficient, and the liquid film cannot be formed, the liquid spreads in a plate shape along the shape of the space region, and a liquid film can be formed. Thus, according to the invention, it is possible to generate a liquid film even from a liquid having a low surface tension.

### BRIEF DESCRIPTION OF THE DRAWINGS

FIG. 1 is a diagram illustrating a configuration example of a liquid film generating tool according to a first embodiment.

FIG. 2 is a diagram illustrating a configuration example of a liquid film generating apparatus to which the liquid film generating tool according to each embodiment is applied.

FIG. 3 is a diagram illustrating a principle by which a liquid film is generated in association with a contour shape of a space region.

FIG. 4 is a diagram illustrating a configuration example of a liquid film generating tool according to a second embodiment.

FIG. 5 is a diagram illustrating a configuration example of a liquid film generating tool according to a third embodiment.

FIG. 6 is a diagram illustrating the principle in which a liquid film is generated in a closed space region according to the third embodiment.

### MODE FOR CARRYING OUT THE INVENTION

### First Embodiment

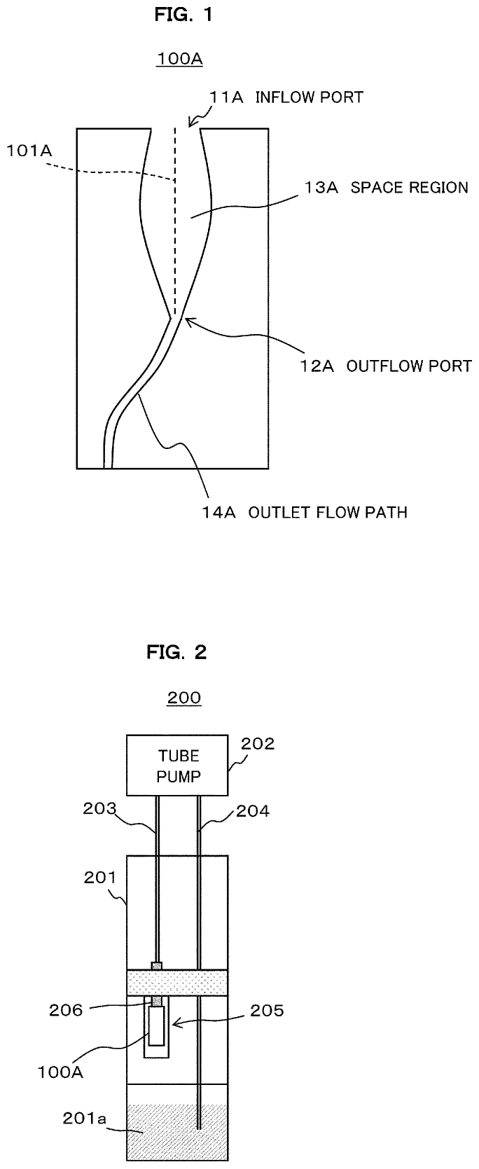

Hereinafter, a first embodiment of the invention will be described with reference to the drawings. FIG. 1 is a diagram illustrating a configuration example of a liquid film generating tool 100A according to the first embodiment. FIG. 2 is a diagram illustrating a configuration example of a liquid film generating apparatus 200 to which the liquid film generating tool 100A according to the first embodiment is applied.

First, a configuration of the liquid film generating apparatus 200 for generating a sample liquid film to be measured by a terahertz spectrometer will be described with reference to FIG. 2. As illustrated in FIG. 2, the liquid film generating apparatus 200 is configured to include a container 201, a tube pump 202, an forward passage piping 203, an backward passage piping 204 and a liquid film cartridge 205. The container 201 is provided with a liquid recovery tank 201a.

The liquid film cartridge 205 is provided with a nozzle 206 for ejecting the liquid to generate a sample liquid film, and the liquid film generating tool 100A according to the first embodiment. For the nozzle 206, for example, it is possible to use the liquid film generating nozzle described in Patent Document 2, but it is not limited thereto. The configuration of the liquid film generating tool 100A will be described later in detail with reference to FIG. 1.

The tube pump 202 sucks up the liquid to be measured from the recovery tank 201a via the backward passage piping 204, pressurizes the sucked up liquid, and derives the liquid to a liquid film cartridge 205 via the forward passage piping 203. The liquid film cartridge 205 ejects the liquid derived by the tube pump 202 from the nozzle 206 and assists the flow of the ejected liquid by the liquid film generating tool 100A, thereby generating a plate-like sample liquid film having a flat surface in a space. The recovery tank 201a recovers and stores the liquid flowing down from the liquid film cartridge 205.

In a case where an amount of liquid that can continue to be ejected from the nozzle 206 is stored in the recovery tank 201a for the period of time required for measuring the terahertz wave from the beginning, it is not indispensable to suck up again and circulate the liquid recovered from the liquid film cartridge 205 to the recovery tank 201a. On the other hand, in a case where the amount of the liquid stored in the recovery tank 201a is less than the amount that can continue to eject liquid from the nozzle 206 for the period of time required for measuring the terahertz wave, it is necessary to circulate and use the liquid.

It should be noted that the liquid film cartridge 205 itself may be used as a container without providing the container 201, and the bottom of the liquid film cartridge 205 may be closed and used as a recovery tank. In this case, the backward passage piping 204 is disposed in the recovery tank provided at a lower part of the liquid film cartridge 205. This structure is particularly effective when a relatively small amount of liquid is used as a sample like the latter.

Next, the configuration of the liquid film generating tool 100A according to the first embodiment will be described with reference to FIG. 1. The liquid film generating tool 100A according to the first embodiment is a jig that is installed at an outlet of the nozzle 206 and assists the water flow of the two string-like fluid columns generated by the nozzle 206, thereby assisting so that the liquid film formation is completed.

As illustrated in FIG. 1, the liquid film generating tool 100A according to the first embodiment includes a liquid inflow port 11A, a liquid outflow port 12A, a flat plate-like space region 13A formed between the inflow port 11A and the outflow port 12A. The liquid ejected from the nozzle 206 is input to the inflow port 11A which is a starting end of the space region 13A. Two string-like fluid columns are formed in the liquid immediately after being ejected from the nozzle 206.

The water flow of the two fluid columns is assisted by a planar shape of the space region 13A, and a liquid film is formed in the space region 13A. The space region 13A serves as an opening portion penetrating from the front surface to the rear surface of the liquid film generating tool 100A, and it is possible to allow the terahertz wave to pass through the liquid film formed here.

The space region 13A has a predetermined thickness. This thickness is designed to be approximately the same as or slightly larger than the diameter of the fluid column formed by the liquid ejected from the nozzle 206.

The planar shape of the space region 13A has a line symmetrical shape on both sides with a center line 101A connecting a center point of the inflow port 11A and the center point of the outflow port 12A as a boundary. A contour of the planar shape of the space region 13A has an arcuate shape that gradually widens toward the outside from the inflow port 11A and then gradually narrows toward the inside to terminate at the outflow port 12A on both sides from the center line 101A. The contour shape of the space region 13A is a shape that assists the water flow of the two string-like fluid columns generated by the nozzle 206 to promote the formation of a liquid film.

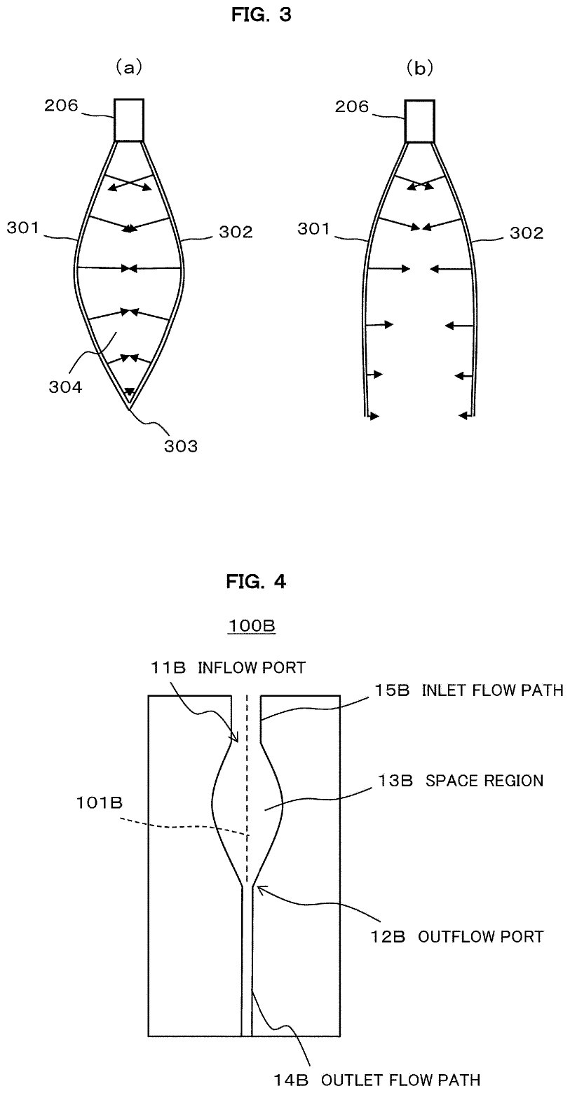

FIG. 3 is a diagram for explaining the principle of generating a liquid film in association with the contour shape of the space region 13A. As illustrated in FIG. 3(a), two fluid columns 301 and 302 formed by the nozzle 206 are pulled toward each other in an inward direction indicated by an arrow, by the surface tension of the liquid film formed between the fluid columns 301 and 302. The surface tension is largest immediately after the liquid is ejected from the nozzle 206 (in the vicinity of the nozzle 206), and decreases as it goes away from the nozzle 206.

When the surface tension is sufficiently large, the surface tensions generated inward from the fluid columns 301 and 302 on the both sides are in a relation of interacting on each other even at the location away from the nozzle 206. Therefore, the two string-like fluid columns 301 and 302 collide with each other at a fluid column assembly point 303, while drawing a smooth arc, and the liquid film 304 is formed by the surface tension of the liquid between the nozzle 206 and the fluid column assembly point 303.

On the other hand, as illustrated in FIG. 3(b), when the liquid ejected from the nozzle 206 is a liquid having a low surface tension such as a surfactant, the surface tensions generated inward from the fluid columns 301 and 302 on both sides interact with each other in the vicinity of the nozzle 206. However, at locations away from the nozzle 206, the surface tensions on both sides do not interact with each other. Therefore, no fluid column assembly point on which the two fluid columns 301 and 302 merge is formed. In this case, the liquid film collapses on the downstream side and becomes liquid droplets.

The planar shape of the space region 13A is configured to have a shape capable of forming a liquid film as illustrated in FIG. 3(a). That is, the planar shape of the space region 13A is configured to have a relation in which, about a surface tension which is generated in the liquid supplied to the space region 13A and which is directed to the inside of the space region 13A from the contour portion of the space region 13A, surface tensions generated from different places in the contour portion (line-symmetric places located on both sides with the center line 101A as a boundary) interact with each other.

That is, the liquid ejected from the nozzle 206 is input from the inflow port 11A in a state in which two string-like fluid columns are formed. The two fluid columns flow along the contour shape of the space region 13A. In this case, inward surface tension is generated from the two fluid columns flowing along the contour shape. Although the surface tension decreases as it goes away from the nozzle 206, the flow of the fluid column is forcibly regulated by the contour shape of the space region 13A and merges at the outflow port 12A. That is, even when the surface tension is small at a position away from the inflow port 11A, there is a relation in which the small surface tensions interact with each other. Thus, the two fluid columns merge at the outflow port 12A. As a result, a liquid film is formed by the surface tension of the liquid between the inflow port 11A and the outflow port 12A.

An outlet flow path 14A is formed ahead of the outflow port 12A. After the two fluid columns merge at the outflow port 12A, the dropletized liquid flows through the outlet flow path 14A, flows down from the liquid film cartridge 205, and is recovered in the recovery tank 201a.

As described in detail above, according to the liquid film generating tool 100A of the first embodiment, when a liquid is supplied from the external nozzle 206 to the space region 13A, two fluid columns are formed along the contour shape of the space region 13A, and liquid spreads in a plate shape between the fluid columns. Surface tension is generated from the fluid column flowing along the contour portions on both sides of the space region 13A toward the inside of the space region 13, in the liquid that spreads in the plate shape in the space region 13A. According to the first embodiment, since the space region 13A is formed in such a shape that the surface tensions of the liquids generated from the contour portions on both sides of the space region 13A interact with each other, even in the case of the liquid in which, if the liquid film generating tool 100A is not used, the surface tension is insufficient and the liquid film cannot be formed, the liquid spreads in a plate shape along the shape of the space region 13A, and a liquid film can be formed. Thus, according to the first embodiment, it is possible to generate a liquid film even from a liquid having a low surface tension.

### Second Embodiment

Next, a second embodiment of the invention will be described with reference to the drawings. FIG. 4 is a diagram illustrating a configuration example of a liquid film generating tool 100B according to the second embodiment. The liquid film generating tool 100B according to the second embodiment is a jig for promoting the liquid film formation, for example, by causing liquid to directly flow into the liquid film generating tool 100B from the forward passage piping 203, without using the nozzle 206 for forming the liquid film, and by causing the liquid to flow along the contour of the space region 13B. The liquid film generating tool 100B according to the second embodiment can also be applied to the liquid film generating apparatus 200 illustrated in FIG. 2.

As illustrated in FIG. 4, in the liquid film generating tool 100B according to the second embodiment, an inlet flow path 15B having a fixed length from an upper end portion thereof is formed, and a space region 13B is formed ahead of the inlet flow path 15B. The boundary portion between the inlet flow path 15B and the space region 13B is an inflow port 11B, and two fluid columns are generated ahead of the inflow port.

The water flow of the two fluid columns is assisted by the planar shape of the space region 13B, and a liquid film is formed in the space region 13B. The space region 13B is an opening portion penetrating from the front surface to the rear surface of the liquid film generating tool 100B, and it is possible to allow the terahertz wave to pass through the liquid film formed here.

The space region 13B according to the second embodiment also has a predetermined thickness. This thickness is designed to be approximately the same as or slightly larger than the diameter of the fluid column generated in the space region 13B.

The planar shape of the space region 13B is a shape which is line-symmetrical on both sides with the center line 101B connecting the center point of the inflow port 11B and the center point of the outflow port 12B as a boundary. Similarly to the space region 13A according to the first embodiment, the contour of the planar shape of the space region 13B also has an arcuate shape that gradually widens toward the outside from the inflow port 11B and then gradually narrows toward the inside to terminate at the outflow port 12B on both sides from the center line 101B. The contour shape of the space region 13B is a shape that assists the water flow of the two string-like fluid columns to promote the formation of the liquid film.

That is, the two string-like fluids generated in the space region 13B flow along the contour shape of the space region 13B. In this case, inward surface tension is generated from the two fluid columns flowing along the contour shape. Although the surface tension decreases as it goes away from the inflow port 11B, the flow of the fluid column is forcibly regulated by the contour shape of the space region 13B and merges at the outflow port 12B. That is, even when the surface tension is small at a position away from the inflow port 11B, the small surface tensions interact with each other. Thus, the two fluid columns merge at the outflow port 12B. As a result, a liquid film is formed by the surface tension of the liquid between the inflow port 11B and the outflow port 12B.

An outlet flow path 14B is formed ahead of the outflow port 12B. After the two fluid columns merge at the outflow port 12B, the dropletized liquid flows through the outlet flow path 14B, flows down from the liquid film cartridge 205, and is recovered in the recovery tank 201a.

As described in detail above, in the liquid film generating tool 100B of the second embodiment, the space region 13B is also formed in such a shape that the surface tensions of the liquids generated from the contour portions on both sides of the space region 13B interact with each other. Thus, even in the case of the liquid in which, if the liquid film generating tool 100B is not used, the surface tension is insufficient and the liquid film cannot be formed, the liquid spreads in a plate shape to conform to the shape of the space region 13B, and a liquid film can be formed. Thus, according to the second embodiment, it is possible to generate a liquid film even from a liquid having a low surface tension.

In the second embodiment, the configuration in which the liquid film generating tool 100B includes the inflow port 11B, the outflow port 12B, the inlet flow path 15B and the outlet flow path 14B has been described, but these are not indispensable configurations in the second embodiment. Also, it is not indispensable to apply to the liquid film generating apparatus 200 having the configuration illustrated in FIG. 1. For example, a liquid sample may be directly supplied from a piping such as a hose to the space region 13B.

### Third Embodiment

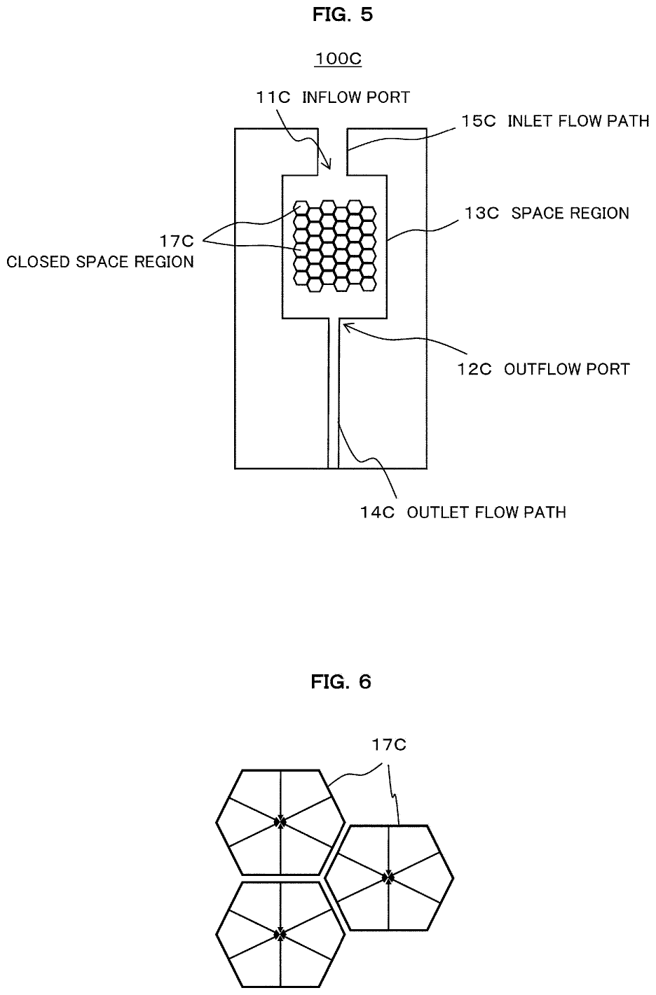

Next, a third embodiment of the invention will be described with reference to the drawings. FIG. 5 is a diagram illustrating a configuration example of a liquid film generating tool 100C according to the third embodiment. The liquid film generating tool 100C according to the third embodiment is a jig which supplies the liquid to a plurality of closed space regions arranged adjacent to each other without using the liquid film generating nozzles 206, thereby promoting the liquid film formation. The liquid film generating tool 100C according to the third embodiment can also be applied to the liquid film generating apparatus 200 illustrated in FIG. 2.

As illustrated in FIG. 5, in the liquid film generating tool 100C according to the third embodiment, an inlet flow path 15C having a fixed length from the upper end portion thereof is formed, and a space region 13C is formed ahead of the inlet flow path 15C. A boundary portion between the inlet flow path 15C and the space region 13C is an inflow port 11C.

The space region 13C in the third embodiment has a plurality of closed space regions 17C. Each of the closed space regions 17C is an opening portion penetrating from the front surface to the rear surface of the liquid film generating tool 100C, and it is possible to allow the terahertz wave to pass through the liquid film formed here.

The space region 13C according to the third embodiment also has a predetermined thickness. This thickness is designed to a value as small as possible so that the structure of the liquid film generating tool 100C can be maintained and the thickness is close to the thickness of the liquid film that is desired to be generated.

The space region 13C in the third embodiment is configured such that the plurality of closed space regions 17C is arranged adjacent to each other at an interval less than a predetermined distance. It is preferable to design the interval of the closed space regions 17C to a value as small as possible within a range in which the structure of the liquid film generating tool 100C can be maintained. This is because the portion between the closed space regions 17C is a portion which is not opened and does not allow the terahertz wave to pass through, so that the region of this portion is made as narrow as possible.

Each of the plurality of closed space regions 17C is configured in a shape in which, about the surface tension which is generated in the liquid supplied to the closed space region 17C and which is directed from the contour portion of the closed space region 17C toward the inside of the closed space region 17C, the surface tensions generated from different places in the contour portion of the closed space region 17C interact with each other. For example, each of the plurality of closed space regions 17C is formed in a honeycomb shape. All the honeycomb shapes have the same shape and the same size.

In the case of the honeycomb shape, as illustrated in FIG. 6, it is configured to have such a size that the surface tensions generated from the mutually opposed sides of the contour portion of the closed space region 17C interact with each other. When the size of the closed space region 17C is too large, the surface tensions generated from the mutually opposed sides of the contour portion do not interact with each other. On the other hand, when the size of the closed space region 17C is too small, it is not possible to allow the terahertz wave to pass through. Therefore, it is necessary to form the closed space region 17C in such a size that the surface tensions interact with each other within a range in which the terahertz wave can be allowed to pass through.

When the wavelength of the terahertz wave is set to 0.3 mm, the focus cannot be narrowed down to 0.3 mm or less due to its physical factor. Therefore, it is necessary to set the generated liquid film to be larger than the width of 0.3 mm. When considering the wavelength band of the terahertz wave to be 0.03 to 3.0 mm, it is necessary to set the liquid film to be generated to be larger than the maximum wavelength of 3.0 mm. Further, it is also necessary to consider the positional deviation at the time of installation of the liquid film generating tool 100C or the occurrence of diffraction phenomenon of light. Therefore, the opposite side dimension of the honeycomb shape constituting the closed space region 17C may be set to a value (for example, about 10 mm) larger than 3.0 mm, in consideration of these points.

In a case where the closed space region 17C is formed in a honeycomb shape, each closed space region 17C is arranged adjacent to each other at positions such that their respective sides are opposite to each other. Further, the arrangement interval is set to be less than the predetermined distance as described above. In this way, as a whole body of the plurality of closed space regions 17C, while securing a large total area of the region of the portion through which the terahertz wave passes, the area of the portion through which the terahertz waves do not pass between the closed space regions 17C can be made as narrow as possible.

As described in detail above, also in the liquid film generating tool 100C of the third embodiment, the space region 13C is formed in a such shape that the surface tensions of the liquids generated from the contour portions of the respective closed space regions 17C constituting the space region 13C interact with each other. Thus, even in the case of the liquid in which, if the liquid film generating tool 100C is not used, the surface tension is insufficient and the liquid film cannot be formed, the liquid spreads in a plate shape to follow the shape of the closed space region 17C, and the liquid film can be formed. Thus, according to the third embodiment, it is possible to generate a liquid film even from a liquid having a low surface tension.

Further, in the third embodiment, the honeycomb shape is illustrated as the shape of the closed space region 17C, but the invention is not limited thereto. For example, a triangle, a quadrangle, a pentagon, an octagon, a circle, or the like may be adopted.

Further, in the third embodiment, the configuration in which the liquid film generating tool 100C includes the inflow port 11C, the outflow port 12C, the inlet flow path 15C, and the outlet flow path 14C has been described. However, these are not indispensable configurations in the third embodiment. Also, it is not indispensable to apply to the liquid film generating apparatus 200 having the configuration illustrated in FIG. 1. For example, a liquid film may be generated in a plurality of closed space regions 17C, by sucking a minute amount of a liquid sample with an instrument such as a spuit or a micropipette, and by dropping a liquid sample from the instrument to the space region 13C. In this way, according to the third embodiment, it is possible to generate a liquid film even from a small amount of liquid less than a certain amount. In particular, even when there is only a small amount that makes it difficult to circulate the liquid by the liquid film generating apparatus 200, it is possible to generate a liquid film.

Further, in the third embodiment, the example in which the plurality of closed space regions 17C is configured to have the same shape and the same size has been described, but the invention is not limited thereto. For example, each of the plurality of closed space regions may be configured to have the same shape and sizes which permit different sizes. For example, a fractal pattern may be formed by a plurality of closed space regions. Alternatively, a pattern corresponding to white noise may be generated on the power spectrum of the two-dimensional Fourier, and the pattern may be subjected to inverse Fourier transformation, thereby forming the plurality of closed space regions.

Further, in the first to third embodiments, processing such as coating the surfaces of the liquid film generating tools 100A to 100C with a specific material may be performed depending on the liquid sample to be used.

Besides, all the first to third embodiments described above are merely examples of implementation of the invention, and the technical scope of the invention should not be interpreted restrictively by the embodiments. That is, the invention can be implemented in various forms without departing from the gist or the main features thereof.

### REFERENCE SIGNS LIST

11A to 11C Inflow port
12A to 12C Outflow port
13A to 13C Space region
14A to 14C Outlet flow path
15B, 15C Inlet flow path
16B Fluid column generating structure
17C Closed space region
100A to 100C Liquid film generating tool

1. A liquid film generating tool comprising a flat plate-like space region having a predetermined thickness,
wherein a planar shape of the space region is configured in a shape in which, about a surface tension which is generated in liquid supplied to the space region and which is directed from a contour portion of the space region toward an inner side of the space region, surface tensions generated from different places in the contour portion interact with each other.

2. The liquid film generating tool according to claim 1, wherein the planar shape of the space region is a line symmetric shape on both sides with a center line as a boundary, and
a contour of the planar shape of the space region has an arcuate shape which gradually widens toward an outer side from a starting end and then gradually narrows toward the inner side to terminate on both sides from the center line 101B.

3. The liquid film generating tool according to claim 1, wherein the space region is formed by arranging a plurality of closed space regions to be adjacent to each other at intervals of less than a predetermined distance, and
each of the plurality of closed space regions is configured in a shape in which, about the surface tension which is generated in the liquid supplied to the closed space region and which is directed from the contour portion of the closed space region toward the inner side of the closed space region, the surface tensions generated from different places in the contour portion of the closed space region interact with each other.

4. The liquid film generating tool according to claim 3, wherein each of the plurality of closed space regions has a honeycomb shape.

5. The liquid film generating tool according to claim 3, wherein each of the plurality of closed space regions has the same shape and the same size.

6. The liquid film generating tool according to claim 3, wherein each of the plurality of closed space regions has the same shape and a size which permits different sizes.

7. The liquid film generating tool according to claim 6, wherein a fractal pattern is formed by the plurality of closed space regions.

8. The liquid film generating tool according to claim 6, wherein a pattern corresponding to white noise is generated on power spectrum of two-dimensional Fourier, and the pattern is subjected to inverse Fourier transformation, thereby forming the plurality of closed space regions.

9. The liquid film generating tool according to claim 4, wherein each of the plurality of closed space regions has the same shape and the same size
